(19) United States
(12) Patent Application Publication
(10) Pub. No.: US 2022/0004991 A1
(43) Pub. Date: Jan. 6, 2022

(54) COLLABORATIVE PROVIDER NETWORK SYSTEM

(71) Applicant: TAPTEN INC., Miami, FL (US)

(72) Inventor: Mildred Maria Villafane, Lomas de Chapultepec (MX)

(21) Appl. No.: 17/477,516

(22) Filed: Sep. 16, 2021

Related U.S. Application Data
(63) Continuation-in-part of application No. 16/273,063, filed on Feb. 11, 2019.
Application No. 16/273,063 is a continuation-in-part of application No. 17/477,454, filed on Sep. 16, 2021.
(60) Provisional application No. 63/079,190, filed on Sep. 16, 2020.

(51) Int. Cl. G06Q 10/10; H04L 12/58; G06F 16/903

(52) U.S. Cl. CPC G06Q 10/101; G06F 3/0482; G06F 16/90335; H04L 51/32

(57) ABSTRACT

The technology described herein relates to social media platform posts that are configured by a media post creator to provide for a selectable action by a post viewer. The action relates to one or more subjects contained in the post. When the post viewer selects the action from a media post, the viewer can procure one or more items associated with the action. The action is configured so that a user initiating the action can procure an item without having to navigate to a non-platform site that makes the item available. Furthermore, post actions can be configured to allow a user to select items from multiple vendors and checkout without leaving the platform. The user only has to perform checkout actions once, even when procuring multiple items from multiple sites.

### CROSS-REFERENCE TO RELATED APPLICATION

This application claims priority to U.S. Provisional Patent Application No. 63/079,190 filed on Sep. 16, 2020 and entitled “Configuring Links in User Created Content.” This application is a continuation-in-part of U.S. patent application Ser. No. 16/273,063 filed on Feb. 11, 2019 and entitled “User Created Content Referral and Search.” This application is also a continuation-in-part of U.S. patent application Ser. No. 17/477,454 filed on Sep. 16, 2001 and entitled “Media Post Interface System and Method of Use.” The entireties of each of the applications identified above are incorporated by reference herein for all purposes, to the extent that no conflict exists between said applications and the statements and drawings set forth herein. If such a conflict exists, the usage of this document controls.

### DETAILED DESCRIPTION

The popularity and evolution of mobile technology and services offered through mobile phones has enabled manufacturers and application developers to bring a great range of possibilities to the market with more features and more power for relatively low prices. The result has been that, over the last several years, mobile phones have become a common and indispensable possession for people around the world. With this tool at their disposal, people are using mobile phone applications such as Google®, Facebook®, Instagram®, Pinterest®, TikTok®, and the like, in record numbers to create content that they share with other users. Such content includes images, text, videos, links, audio, etc. that are of interest to a user creating a post.

In the system and methods described herein and in “Media Post Interface System and Methods of Use,” referenced above and filed concurrently herewith, a system allows creators of media posts to add action items to posts. The action items link providers with post viewers so viewers can purchase goods or services related to the media post. Some providers are in a situation where they need to partner with one or more other providers in order to improve provision of their goods or services. Using the systems described herein, providers can work within the provider network to find provider partners to work with to provide goods and services. For example, a provider might sell products online, and they may be available to users viewing a post included in a media application. But they may not have the best resources for providing their products and they may need to improve on some aspect of their provision techniques. For instance, the provider might not have an ideal and efficient shipping solution, in which case they may be providing an ad hoc shipping solution to each order they receive. Using the techniques described herein, the provider may locate a provider in the shipping industry that they can join with to provide better shipping solutions.

### BRIEF DESCRIPTION OF THE DRAWINGS

The Detailed Description, below, makes reference to the accompanying figures. In the figures, the left-most digit(s) of a reference use of the same reference numbers in different figures indicates similar or identical items.

FIG. 1 is a representation of a smart phone depicting a user interface utilized in the techniques presented herein, the user interface for creating a content referral.

FIG. 2 is a representation of a smart phone showing an example user interface depicting a first action assignment view state of an action assignment process.

FIG. 3 is a representation of a smart phone showing an example user interface depicting a second action assignment view state of an action assignment process.

FIG. 4 is a flow diagram that depicts a process for adding an action item to a content referral for posting.

FIG. 5 is a block diagram of an example phone that may be used to implement the presently described techniques.

FIG. 6 is a block diagram of an example server that may be used to implement the presently described techniques.

FIG. 7 is diagram depicting additional details of the action creation process generally described with respect to FIGS. 1-4, as well as an API generation process.

FIG. 8 is a diagram depicting a process associated with creation of a cart associated with a user and with one or more products selected for purchase by the user.

FIG. 9 is a diagram depicting a process associated with a final checkout by a user who has selected items for purchase.

FIG. 10 is an illustration of an example APCC system configured to perform the steps and functionality described below.

FIG. 11 is a flow diagram depicting an example methodological implementation of a collaborative provider network system.

FIG. 12 is a flow diagram depicting an example methodological implementation of a participant's role in a collaborative provider network system.

### DETAILED DESCRIPTION

The technology described herein relates to interfaces used in media posts to create and communicate with an action that has been included in a media post by a creator to the post. As used herein, the term “action” or “action item” refers to a process associated with a media post, wherein a viewer of the post can actuate an icon to execute the process to perform a task. As used herein, the term “media post” or “post” refers to content that a user creates and uploads to a network and/or an application, such as a social media application. Some terms used herein are defined in the parent application, U.S. patent application Ser. No. 16/273,063 entitled “User Created Content Referral and Search,” referenced above and incorporated herein. If there is a conflict of terms between the present application and the parent application, terms as defined in the present application shall control. To clarify the present discussion, the term “User 1” as used herein refers to a user who creates a content referral in the systems defined herein and in the parent application, and who may execute an action creation process to add one or more procurement items (e.g., products, services, tickets, reservations, etc.) to their content referral prior to posting their content referral. “User 2” is used herein to refer to a user who views a posted content referral (i.e. a “post”) and who may select an action icon to execute the action process(es) to procure a listed item. After User 1 creates and posts a content referral that includes an action item, User 2 can actuate an icon associated with the action item to access and select one or more procurement items. Although the present discussion refers to “content referrals,” the presently described techniques may be used with any type of known system or process for posting content.

One particular advantage of the techniques described herein is that a user can procure a procurement item without having to leave the trusted content referral system platform and go to a different site to complete a purchase or procurement. The user can provide information to the platform and the platform will provide information needed to complete the procurement. In at least one implementation, a user stores shipping and payment information in the system and may purchase at item by simply clicking a “purchase” icon without going through a typical shopping cart process. In this way, actions are more than simply a link embedded in a post, which is a common way for platforms to provide access to particular procurement items to users.

Similarly, the present techniques can be used to provide a user a way to purchases goods/services from multiple sites without having to enter personal or payment information for each site or to transfer to any of the multiple sites. This provides the advantage of reducing user and computer resources to visit individual sites and enter information at each site.

In addition to the foregoing, the present techniques also provide a feedback and learning mechanism whereby the system monitors creation and completion of APIs and learns how to assist users and in the API creation process.

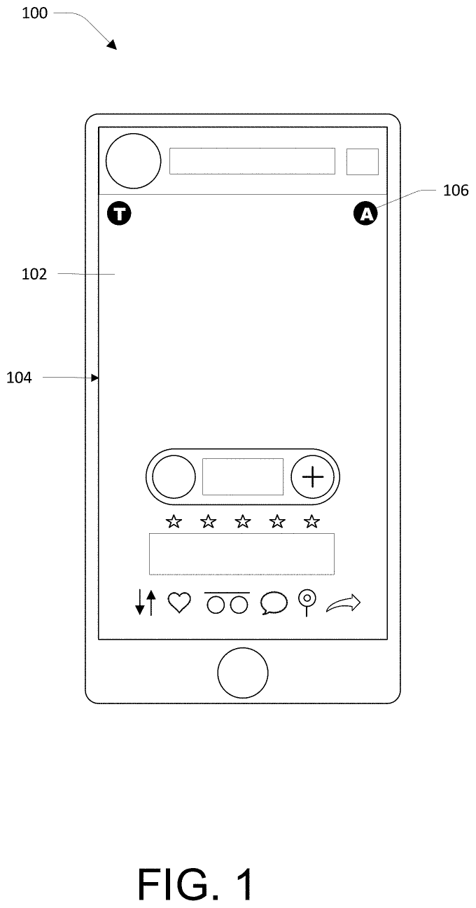

Other benefits and advantages of the described techniques will be clear to a person having ordinary skill in the art in light of the technological advancements of the systems and methods described herein with reference to corresponding FIGS. 1-9.

### Content Referral System: Action Creation User Interface

FIG. 1 is a representation of a smart phone 100 that depicts an example user interface 102 that is used to create an action in a content referral system as described in the parent of the present application. The smart phone 100 includes a display 102 shown displaying a user interface 104 from which User 1 can add an action to a content referral created by User 1. The user interface 104 includes an action icon 106 that is selectable by User 1 to initiate the action creation process(es) described herein. Continuing reference will be made to FIG. 1 and the elements contained therein throughout the present description to describe features of the claimed techniques.

### Action Assignment: First Action Assignment View

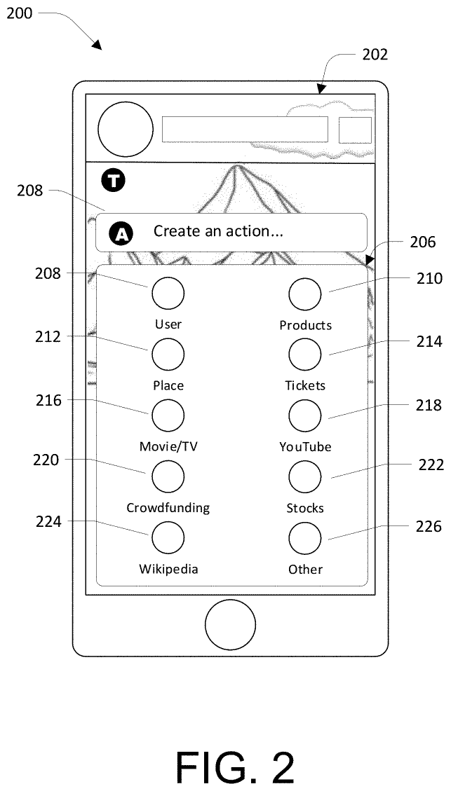

FIG. 2 is a representation of a smart phone 200 showing an example user interface 202 that depicts a first action assignment view of an action assignment process. After User 1 selects the action icon 106 (FIG. 1), User 1 is presented with the user interface 202 shown in FIG. 2. The user interface 202 includes a first dialog box 204 that identifies the user interface 202. The user interface 202 also includes a second dialog box 206 that displays a number of different types of actions (or action categories) that can be associated with the content referral created by User 1. As shown in the present example, the user interface 202 includes a number of selectable action icons 208-226. A selectable icon is associated with a particular type of procurement item that is selected and associated with a content referral.

As shown in FIG. 2, the following selectable action icons are shown:
User action icon 208: an action that adds a user contact or profile to an action and is used to go directly to a user profile, where another action may be performed, such as contacting the user, acquiring a coupon associated with the user, contacting the user associated with the user profile, schedule an appointment or service with the user, etc.;
Product action icon 210: an action that displays one or more products associated with a subject matter of a content referral;
Place action icon 212: enables User 1 to add information about a specified place (restaurant, etc.), dial a phone number specified in an action, etc.;
Tickets action icon 214: an action that enables User 2 to view/purchase tickets for an event;
Movie/TV action icon 216: an action that takes User 2 directly to one or more movies or television shows that are related to the subject matter of a content referral, e.g., “Jennifer Anniston,” etc.
YouTube® action icon 218: obtains a video available on YouTube®;
Crowdfunding action icon 220: obtains information and interacts with and executes a crowdfunding source procurement process;
Stocks action icon 222: allows User 2 to view and purchase equities;
Wiki action icon 224: retrieves information from a public site (in this case) for User 2;
Other action icon 226: used either to provide a secondary list of action items available to User 1, or to create a custom action item.

Continuing reference will be made to FIG. 2 and the elements contained therein throughout the present description to describe features of the claimed techniques.

### Action Assignment: Second Action Assignment View

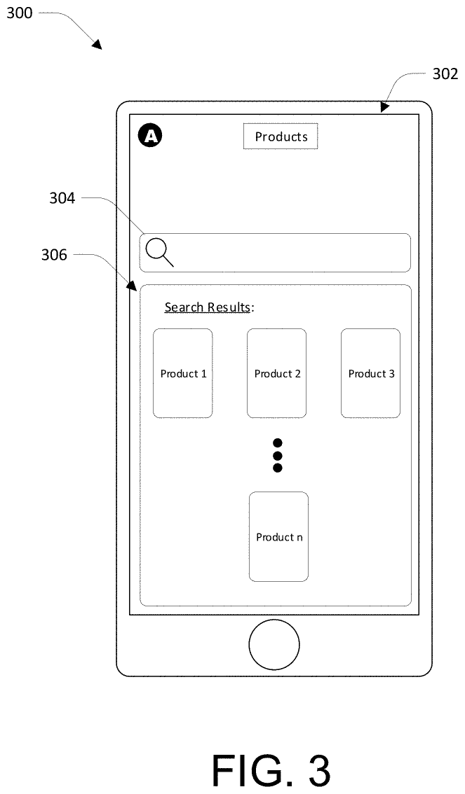

FIG. 3 is a representation of a smart phone 300 showing an example user interface 302 that depicts a second action assignment view of an action assignment process. The user interface 302 includes a search dialog box 304 and a search results dialog box 306. When creating a product action item (the present example is related to an action that features a product), User 1 enters a search term in the search dialog box 304 so that User 1 can locate one or more providers that sell a product shown in a content referral. The search results from such a search are shown in the search results dialog box 306. User 1 may then select one or more of the products shown in the search results dialog box 306 to add information to an action that enables User 2 to select a product and procure the product using the techniques described herein.

Continuing reference will be made to FIG. 3 and the elements contained therein throughout the present description to describe features of the claimed techniques.

### Action Assignment Methodological Implementation

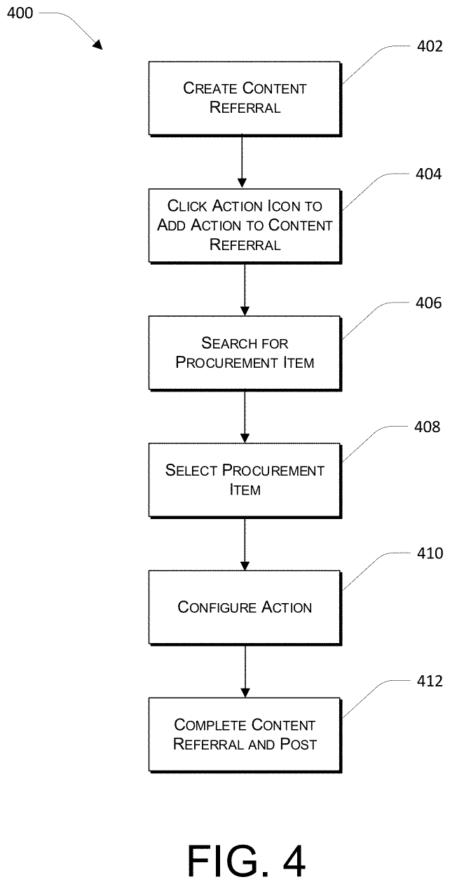

FIG. 4 depicts a flow diagram 400 that depicts a process for adding an action item to a content referral for posting. The following discussion of FIG. 4 refers to one or more previous figures using the same description and reference numerals associated therewith.

At step 402, User 1 begins the process to create a content referral. The content referral process is described in detail on the parent application hereto. At step 404, User 1 clicks on the action icon 106 (FIG. 1) to initiate a process for adding an action to the content referral. At step 406, User 1 searches for a procurement item (e.g. a product, a service, etc.) to include in the content referral and selects one or more appropriate procurement items at step 408. At step 410, User 1 configures the action as further described hereinbelow. When the action has been completed, User 1 completes creation of the content referral and posts the content referral at step 412.

### Actionable Post Checkout Container System—Phone

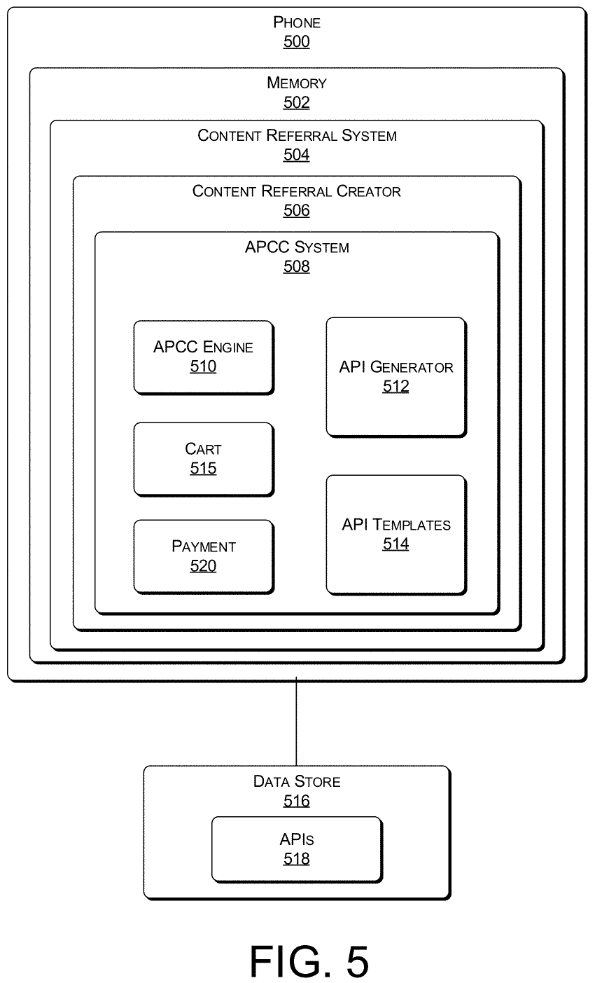

FIG. 5 is a block diagram of an exemplary phone 500 that may be used to implement the present techniques. The exemplary phone 500 includes at least memory 502 in addition to other operational hardware element not shown. A content referral system 504 is stored in the memory 502 and includes modules necessary to implement content referral creation and usage as described in the parent application. The content referral system 504 includes a content referral creator 506, which includes an APCC (Action Post Checkout Container) system 508. The APCC system 508 includes an APCC engine 510 and an API generator 512. If a provider does not have a developed API for their product(s), the API generator 512 assists the provider to develop an API for use with the system, the API conforming to the system protocols and containing information particular to the provider. The APCC system 508 also stores multiple API templates 514, each API template being associated with a particular type of procurement item (product, event, reservation, etc.). The APCC system 508 also includes a cart 515 that stores items selected for purchase by a user. A data store 516, which may be included on the example phone 500 or a server (not shown) stores multiple APIs 518 generated by the APCC system 508 by techniques describe in greater detail below. The APCC further includes a payment module 520 that works in conjunction with the cart 515 to determine payments to providers, users, platform, etc. The payment module 520 is described in greater detail below.

### Actionable Post Checkout Container System—Server

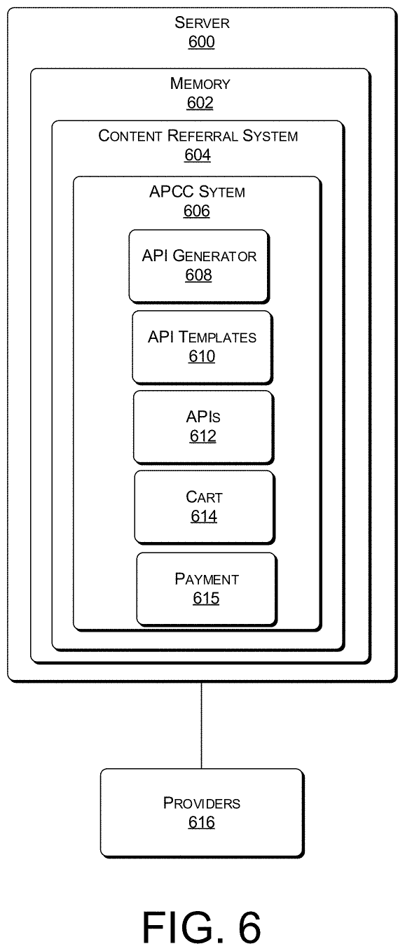

FIG. 6 is a block diagram of an exemplary server 600 that may be used to implement the techniques described herein. The exemplary server 600 includes at least memory 602, which stores a content referral system 604. The content referral system 604 includes an APCC system 606. The APCC system 606 includes an API Generator 608, multiple API templates 610, and stores multiple APIs 612. The APCC system 606 also includes a cart 614 that stores items selected for purchase by a user. The APCC further includes a payment module 615 that works in conjunction with the cart 614 to determine payments to providers, users, platform, etc. The payment module 615 is described in greater detail below. FIG. 6 also shows multiple providers 616 that interact with the server 600. The elements and functionality of FIG. 6 are described in greater detail below.

### API Creation

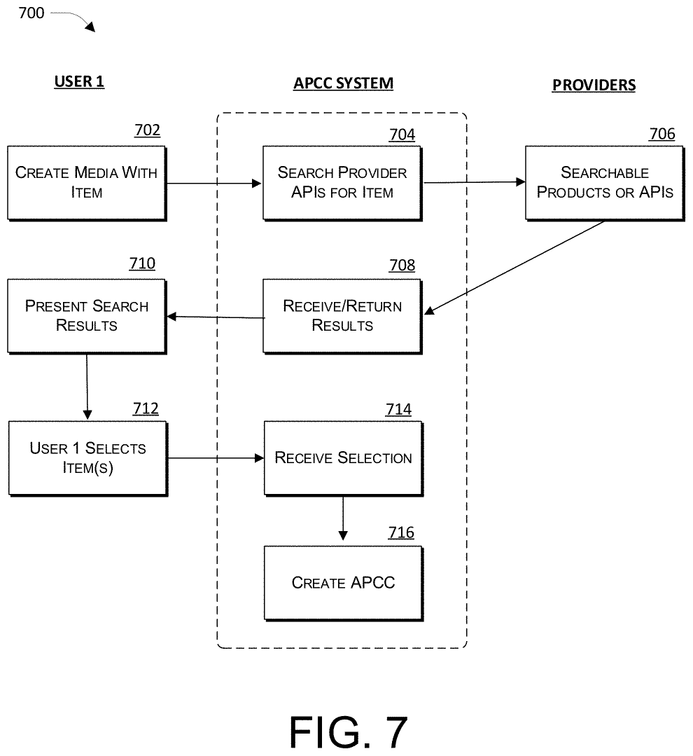

FIG. 7 is a diagram 700 depicting additional details of the action creation process generally described with respect to FIGS. 1-4, as well as an API generation process. The following description of FIG. 7 refers to one or more previous figures, using similar element names and reference numerals. In the following example, the description relates to a product chosen by User 1 to relate to his action item. In other examples, User 1 may select a different type of procurement item, such as an event, a reservation, an appointment, etc.

At 702, User 1 creates a content referral with selected media and invokes the action creation process. At 704, the APCC engine 510 (FIG. 5) selects an API template (514, 610) that corresponds with the type of procurement item (product, event, reservation, etc.). At 706, the APCC engine 510 (FIG. 5) invokes a search for possible procurement items to include in the content referral, searching provider sites for matching products. At this point, the APCC engine can also search pre-populated provider APIs to determine if an API for a matching product from the provider has already been created and stored (514, 612). At 708, the providers having an item that matches the search criteria or a pre-loaded API returns necessary matching item information (provider id, product id, keywords, etc.) to the APCC engine, which receives the results (710) and presents the results to User 1 (712). In addition to basic information, the provider, through an API with the APCC system, may also provide other relevant information such as coupons, promotions, tax information, etc.

At 714, User 1 selects one or more items from the displayed items and the selection is received at 716. At 718, the API generator 512 populates the previously selected API template for each selected product or identifies a matching pre-populated API from a provider. The appropriate API is stored at 720 for use in one or more subsequent processes, such as a checkout process. Also at 720, the APCC engine 510 may send and store user psychographics, demographics, behavioral data, etc. to the API generator 512. Such data may update certain aspects of the APCC engine 510 to use for future reference in assisting providers select and create efficient APIs through the API generator 512.

An example API template for a product is shown below:

```
Class: Item
Methods:
  Get item:
    Inputs:
      Vendor ID
      Item ID
  Find item:
    Inputs:
      Vendor ID
      Item Name
      Keywords
    Outputs:
      List of Vendor item IDs
```

Other procurement items, such as event tickets, reservations, stocks, etc. may have a unique API associated with them to accommodate the various information that is required for each type of procurement item. For example, an API associated with a restaurant reservation may not require an Item ID like an API associated with a product might. Each type of procurement item may have its own unique API.

In one or more implementations, providers (of products, services, etc.) may store API templates to be used with purchases from their store. Such API templates can be pre-populated with provider information to expedite the API creation process. In such cases, rather than populate a blank API template, the API generator 512 identifies the pre-existing provider API template and populates it with additional information. In yet other implementations, providers may store a fully-populated API associated with each product made available by the provider. In such cases, the API generator only has to retrieve an API that is associated with a selected product.

### Checkout Process: Cart Creation/Updates

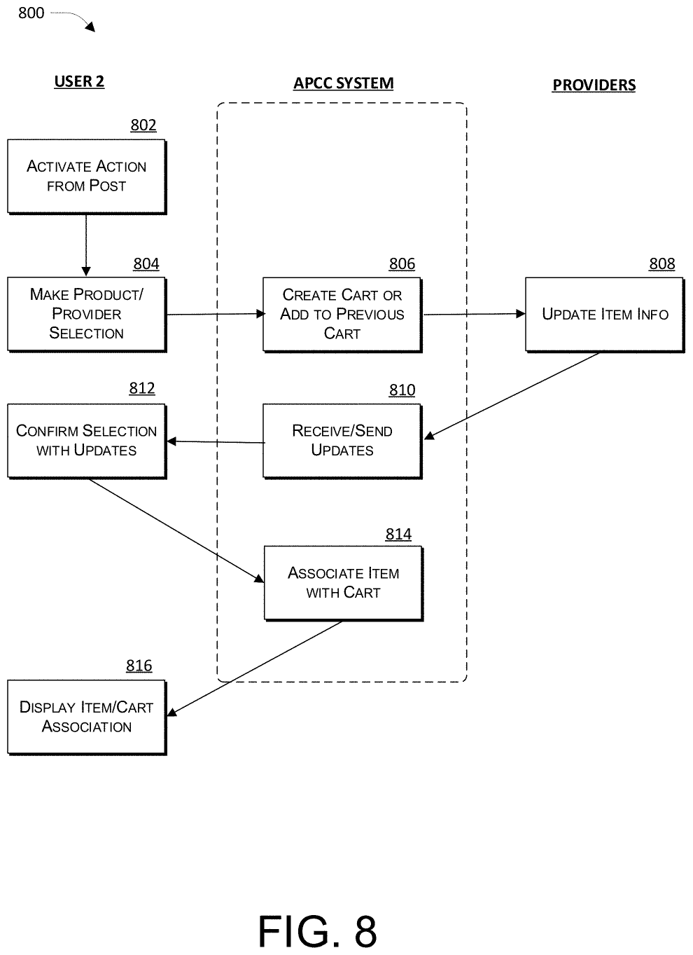

FIG. 8 is a diagram 800 depicting a process associated with creation of a cart associated with User 2 and with one or more products selected for purchase by User 2. The following description of FIG. 8 refers to one or more previous figures, using similar element names and reference numerals. In the following example, the description relates to a product for purchase chosen by User 2 from a post made by User 1. In other examples, User 1 may select a different type of procurement item, such as an event, a reservation, etc.

At 802, User 2 activates the action icon 106 (FIG. 1) from a post containing a content referral (created by User 1). Upon selection of an item to purchase at 804 (selecting the item and the provider of the item), the APCC system 508 creates a cart or associates the selected item with an existing cart that is associated with User 2 at 806. As explained in greater detail below, the cart may contain items from different providers, enabling User 2 to place an item from a first provider in the cart and continue shopping, ultimately placing a second item in the same cart. The APCC system 508 verifies item information—such as availability, pricing, etc.—at 808 and updates information if necessary. The verified/updated information is received by the APCC system 508 at 810 and it is transmitted to User 2 at 812, so that User 2 can view the verified/updated product info and decide to continue or cancel the transaction. If User 2 confirms the purchase, then the item is associated with the cart at 814. User 2 then receives confirmation that the item is in a cart and ready for checkout.

It is noted that User 2 may continue to add items to the cart, even if additional items are available from a different provider. In this way, User 2 can collect multiple items from multiple providers in his cart. As is described in greater detail below, when User 2 checks out, he can simply go through a single process where User 2 personal information and payment information is provided to the APCC system. The APCC system, as shown below, then provides necessary information to each vendor to procure the items.

If User 2 wants to modify the cart (515, 614) after it has been created, User 2 activates a cart icon to display the cart contents. User 2 can then delete one or more items from the cart, or update a product in the cart, such as a quantity, color, etc. When User 2 takes such an action, the APCC system (508, 606) returns to the provider of the updated product to check availability of a product that matches the updated product identified by User 2. The provider(s) sends updates to the APCC system, which relays the information to User 2. If the updated selection is unavailable, User 2 may elect to stay with the original item, update characteristics of the product (initiating a new update with the provider) or delete the product from the cart. By this manner, User 2 is assured that he is purchasing the product he wants and that it is available from a provider through the APCC system.

Example API templates related to a cart is shown below:

```
Class: Cart
Methods:
  Get cart
    Inputs:
      Customer id
      Cart id
  Create cart:
    Inputs (optional):
      Items
      Customer id
      Currency
      Vendor(s) id
    Outputs:
      Cart id
      Timestamp
  Delete cart:
    Inputs:
      Cart id
  Add item:
    Inputs:
      Item id
      Cart id
  Update Item
    Inputs:
      Item id
      Cart id
  Delete Item
    Items:
      Item id
      Cart id
```

### Checkout Process: Final Checkout

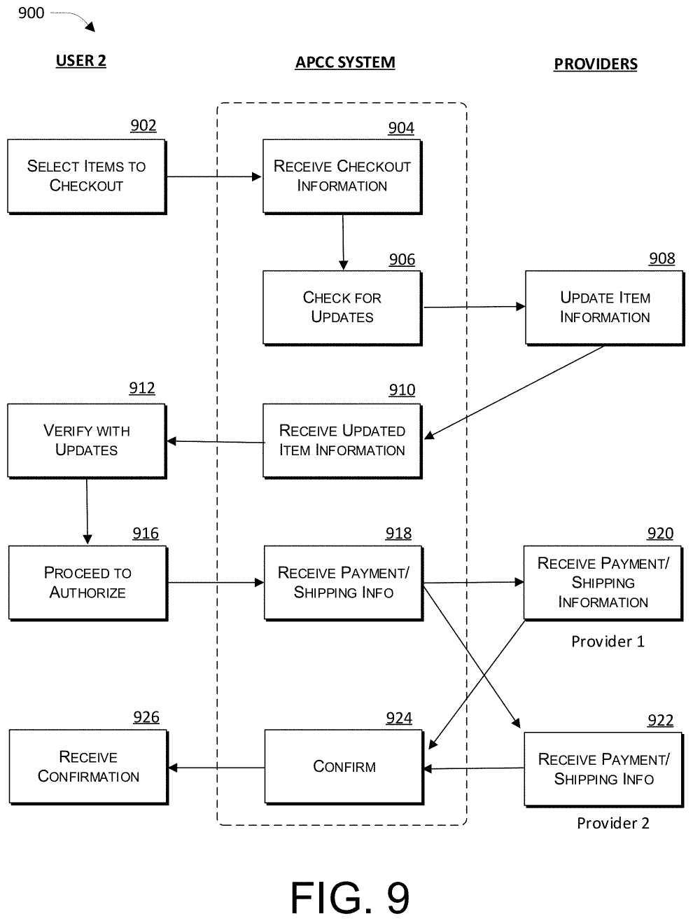

FIG. 9 is a diagram 900 depicting a process associated with a final checkout by User 2. The following description of FIG. 9 refers to one or more previous figures, using similar element names and reference numerals. In the following example, the description relates to two products in a cart created by User 2. In other examples, checkout may be for only a single item or for more than two items.

At 902, User 2 opens a previously created cart and selects items for which User 2 wants to proceed to checkout and finalize purchase. User 2 may select one or multiple items from the cart, depending on what User 2 is ready to purchase. This makes the cart system described herein similar to a wish list in that User 2 can hold items in his cart to purchase at a later date. The present example assumes User 2 selects two items from his cart for purchase. The two items may be from the same or different providers. At 904, the APCC system receives the selections and at 906, it checks for updates. An update is desirable at this time because it may have been some time since User 2 created the cart and logistics related to the selected items may have changed, such as availability, pricing, etc. At 908, the provider(s) update the information, including whether any credits are available to User 2 from promotions or the like. At 910, the APCC system receives the updated item info and passes it to User 2. At 912, User 2 verifies the updates and may elect to cancel the order (914) or to proceed to authorize the APCC system to continue with the purchase.

At 918, the payment module (520, 615) receives the information needed to complete the purchase, including payment data and shipping information. This information may be input by User 2 at this time, or it may be retrieved from the payment module if User 2 has previously stored such information. The APCC system (508, 606) then relays the payment/shipping information to a first provider (920) and to a second provider (922). The providers confirm the purchase at 924 and User 2 receives confirmation at 926.

In at least one alternate implementation, User 2 doesn't have to provide payment information to the providers. Instead, User 2 may elect to make the total payments to the APCC system directly which, in turn, provides payment to the providers. In this way, User 2's financial security is further protected by only having to provide payment credentials to one trusted entity. In this way, User 2 also saves a significant amount of time.

Example API templates related to a checkout is shown below:

```
Class: Checkout
Methods:
  Get checkout
    Inputs:
      Cart id
    Outputs:
      Checkout id
  Process checkout
    Inputs:
      Checkout id
      Payment id
      Vendor Access ids
    Outputs:
      Success
      Vendor Sale id
  Update checkout
    Inputs:
      Checkout id
      Addresses
      Coupons
      Gift certificates
      Store credits
      Payment methods
      Vendor access is
      Shipping
      Tax information
    Outputs:
      Success
```

### Monetary Incentives

One incentive contemplated by the techniques disclosed herein is to pay users (i.e. User 1) a commission when another user makes a purchase through the user's (User 1's) post. For example, if User 1 creates a post and adds an action item for Nike backpacks and User 2 purchases a Nike backpack by initiating the action item in User 1's post, an arrangement may be made whereby User 1 receives a portion of the purchase price of the Nike backpack purchased by User 2. Such an arrangement would contemplate the commission or incentive payment from the Content Referral system directly or from the provider from which User 2 purchased the backpack. Payments from providers to users may be made directly to users according to a pre-arranged agreement with providers and the Content Referral system. Or, the Content Referral system may have an agreement with providers to take a portion of the remitted payment for items and send it to the users. In such a case, the payment module stores commission information for each provider. When the system collects payment from User 2, it would provide appropriate amounts to the providers and to User 1. In an alternate implementation, such a commission is paid to the operator of the system as compensation. Such an arrangement could be made to reduce advertising on the platform or to maintain system operations.

### Provider Network System

The techniques described herein are also useful to providers who collaborate to make products and services available to system users. An extension of that idea is that providers who need to collaborate with one or more other providers to market a product or a service may use a related system to seek collaborators and, once collaborators are found, to jointly make their products or services available through the media post system.

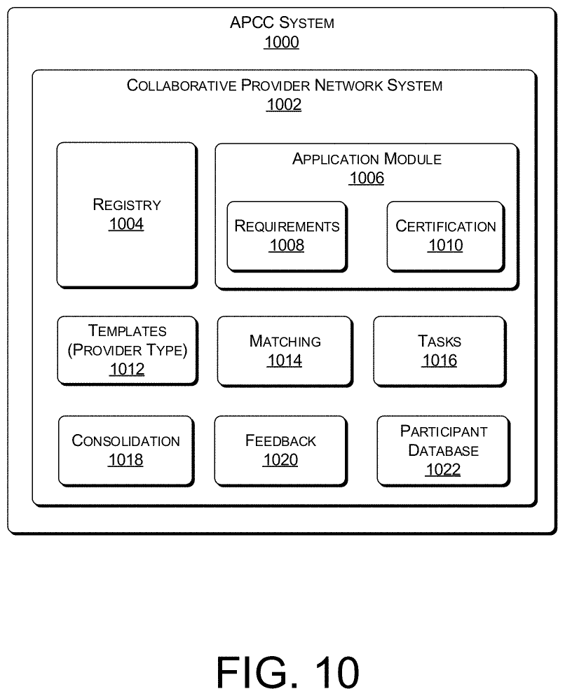

FIG. 10 is an illustration of an example APCC system 1000 configured to perform the steps and functionality described below. The APCC system 1000 can be the same as the APCC system 508 (FIG. 5) and/or APCC system 606 (FIG. 6) previously shown. The elements shown in APCC system 1000 are in addition to elements shown in APPC system 508 and APCC system 606.

The example APCC system 1000 includes a collaborative provider network system 1002, which includes a registry 1004 and an application module 1006. The registry 1004 is used to register users and provide credentialed user access to the system. The application module 1006 includes a requirements module 1008 and a certification module 1010. Generally, the application module 1006 stores different types of applications, each application being tailored to a specific type of collaboration a user wants to explore. For example, if a user has a manufacturing business and is looking for partner merchants, distributors, shippers, etc., then the user will select an application tailored to such a scenario. The requirements module 1008 provide a way for the user to enter requirements for his collaboration. In the previous example, the shoe manufacturer would indicate that he is looking for shoe outlets to sell his product (among other possibilities). The application module 1006 analyzes the requirements to determine what application to provide to the user. The certification module 1010 tracks adherence to system protocols to ensure that the user has entered information correctly and as completely as possible.

The collaborative provider network system 1002 also includes application templates 1012 that are used to prompt a user to enter pertinent information as described above. The collaborative provider network system 1002 further includes a matching module 1014, a tasks module 1016, a consolidation module 1018, and a feedback module 1020. The matching module 1014 takes the user requirements from the template completed by a user and locates possible collaborative providers from providers registered with the system. In addition to finding possible matches for the requirement(s) entered by the user, the matching module 1014 also locates providers that may be related to the user's request and can make suggestions to the user regarding potential collaborative providers that are not in an exact category defined by the user.

Examples of types of provider that the matching module 1014 may recommend for a user include, but are not limited to, the following:
Production/manufacturing
Packing
Delivery
Warehousing
Inventory Control
Customer Service
Marketing
Media Production
Advertising
Crisis Management
Public Relations
Sales
Research and Development
Investors
Headhunters
Developers
Office Space Landlords
Legal Providers
Insurance Providers
Performance Measurement
Communication Processes/Management
Design
Strategy Consultants
Accounting
Compliance/Auditing

In addition to the foregoing, the matching module 1014 may evaluate certain characteristics of the user requirements (as identified in the application) to identify potential collaborative partners. Such evaluations may consider the following factors:
Needs
Business similarities
Customer demographics
Provider location and service areas
Existing provider relationships
Type of providers
Capacity and response limits
Territorial regulations
Business opportunities
Technological tools
Other considerations

In sum, the matching module 1014 seeks to evaluate potential provider partners for a user on as many conditions and characteristics as possible. Alternate implementations may use any combination of the elements listed above and/or may include elements not listed here without departing from the scope of the invention.

The tasks module 1016 generates a task list to provide to the user that informs the user of what things the user will need to complete to further the collaboration. In the example of the shoe manufacturer, tasks provided by the task module 1016 may relate to certain agreements that the manufacturer likely needs to complete with collaborative retail outlets, etc. The consolidation module 1018 verifies that all the information from the collaborative providers has been obtained, and that the collaborative providers are ready to register their collaborative product/service with the system. The feedback module 1020 collects feedback from user surveys, provider surveys, collaborative system participants, etc. in order to fine tune and improve the system and process. A participant database 1022 stores applications from participants that are available to collaborate with a potential provider as described below.

### Methodological Implementation: Collaborative Provider Network System

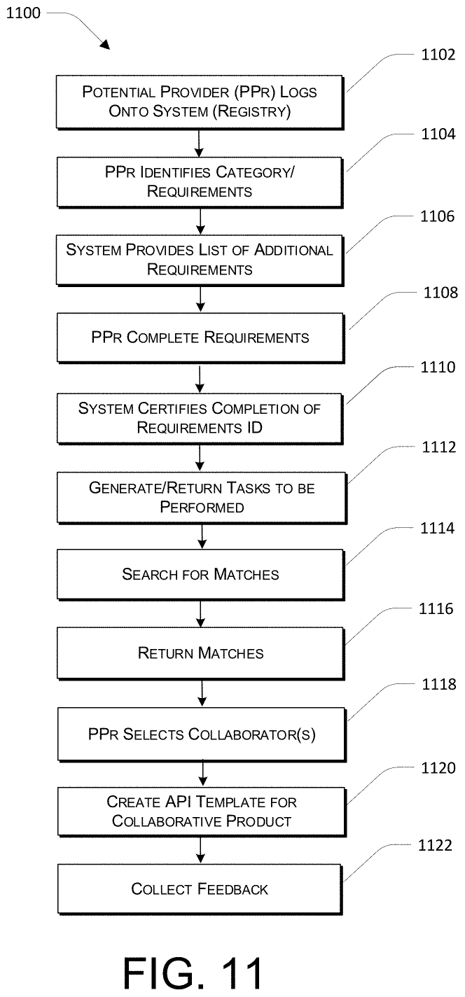

FIG. 11 is a flow diagram 1100 depicting an example methodological implementation of a collaborative provider network system. In the following discussion of FIG. 11, continuing reference is made to one or more previous figures shown and described herein. References to other figures will contain similar elements and reference numerals described in relation to those figures previously. It is noted that although the steps are shown in a particular order, the described steps can be performed in any order without departing from the scope of the invention.

At 1102, a potential provider logs onto the APCC system 1000 (FIG. 10) by way of the registry module 1008. The application module 1006 prompts the potential provider to provide the potential provider's category and requirements via an application process at 1104. At 1106, the APCC system 1000 provides a list of additional requirements to the potential provider that the potential provider may not have thought about needing. At 1108, the potential provider completes entry of his requirements into the APCC system 1000.

At 1110, the certification module 1010 certifies that the potential provider has completed the entry of requirements and identification data. At 1112, the task module 1016 generates tasks that the potential provider will need to perform to collaborate with a participant of the type sought by the potential provider. The matching module 1014 searches for matches based on potential provider supplied information and elements inferred by the matching module at 1114. At 1116, the matching module 1014 returns a set of search results and displays them to the potential provider.

At 1118, the potential provider selects one or more participants (i.e., potential collaborators) from the matching candidates and the system provides means to communicate between the potential provider and participants. A network tasks automation process provides a series of templates and tools for advancement of negotiations and agreements for better closure of the collaborators and their roles and responsibilities. Once this is established, a chain processes project manager makes sure that all the chain processes are being executed on time and according to protocols and templates and that each participant is fulfilling its roles, responsibilities, inputs, outputs, deliveries, etc. in order the achieve collaboration objective. At 1120, the collaborating providers (formerly the potential provider and the participant(s)) create an API template for their collaborative product or service.

At 1122, the feedback module 1020 collects feedback on the process. This can be done by sending surveys to the participants or by receiving ratings and suggestion from one or more of the participants. The feedback received may be used by the APCC system 1000 to crop or expand requirements for particular types of providers, tasks for applicants, etc. The process may be automated or it may be performed manually by an administrator of the system 1000.

### Methodological Implementation—Participant Process

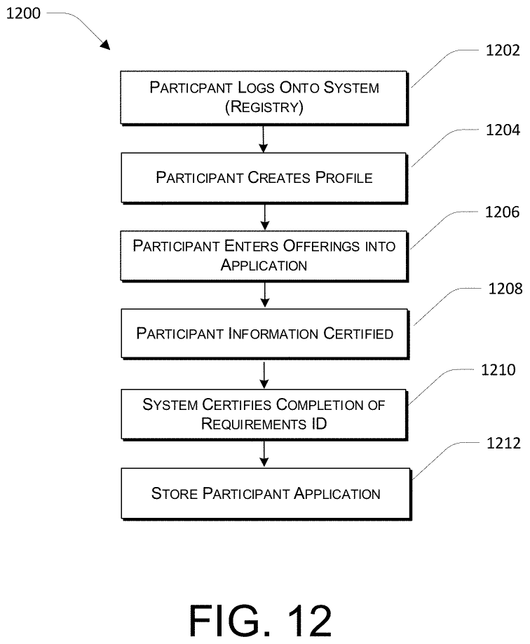

FIG. 12 is a flow diagram depicting an example methodological implementation of a participant's role in a collaborative provider network system. In the following discussion of FIG. 12, continuing reference is made to the elements and reference numerals of previous figures. It is noted that although the steps are shown in a particular order, the described steps can be performed in any order without departing from the scope of the invention.

Generally, the following process relates to how an entity that is available to collaborate with a provide of a good or service by providing some aspect of the production, marketing, or support of the good or service. Such an entity is described below as a “participant.” At 1202, a participant logs onto the onto the APCC system 1000 (FIG. 10) by way of the registry module 1008. The registry module 1008 creates a profile for the participant by receiving relevant information from the participant (1204). The application module 1006 prompts the participant to provide the participant's offerings via an application process at 1206. An “offering” is a good or a service offered by the participant that a potential provider may desire to incorporate in the creation/production of a good or service sold by the potential provider or which the potential provider wants to create and sell. For example, if a participant is a software developer, the participant can create an application that identifies his offering of developer services to a potential provider that needs to hire a software developer.

At 1208, the requirements module 1008 evaluates the participant input and prompts the participant to enter additional information if necessary. At 1210, the certification module 1010 verifies that all the appropriate information has been entered by the participant to be available as a potential collaborator in the system. At 1212, the APCC system 1000 stores the participant application in the participant database 1002 where it is available to be matched with a potential provider for a possible collaboration.

### Assist Functions

Throughout the processes described above, certain assist functions are available to potential providers, participants, and collaborators. Such functions include tutorials/training materials that describe how to use the system and navigate the process, a communication function that provides ways for users to users to communicate with each other, and a provider network customer service function that provides individualized support to system users. Another available function is an internal evaluation function that allows collaboration participants to evaluate and review different aspects of the collaboration. An external review function is available to provide reviews, data insights, marketing research, feedback, etc., that helps the system improve its services.

An invitation function provides a way for a user to invite other providers to join the network through, e.g., links, posts, emails, etc. A recommendations function is available for a provider to recommend one or more new providers to enter a collaboration. Finally, a panic button function is available and can be activated by any provider when one or more providers in its collaboration is not performing up to the collaboration agreement. When that happens, a process is available to find a replacement for the underperforming collaborator provider.

### General Operating Environment

The embodiments described herein may be implemented in software that runs on one or more computing devices. The one or more computing devices may be equipped with a communication interface, a user interface, one or more processors, and memory.

The communication interface may include wireless and/or wired communication components that enable the computing device to transmit or receive data via a network, such as the Internet. The user interface may enable a user to provide inputs and receive outputs from the computing device.

The user interface may include one or more data output devices (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

Each of the processors may be a single-core processor or a multi-core processor. Memory may be implemented using computer-readable media, such as computer storage media. Computer-readable media includes at least two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray, or other optical storage, magnetic cassettes, magnetic tape, magnetic disk storage or other magnetic storage devices, or any other non-transmission medium that may be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

1. A method of providing a collaborative product, comprising:
registering a potential provider;
receiving information from a potential provider identifying a provider category and requirements for a collaborative provider partner;
determining if additional requirements are needed and, if so, requesting and receiving information related to the additional requirements from the potential provider;
certifying that all necessary requirements have been received;
searching a participant database for a potential collaborator for the potential provider;
receiving a selection of a potential collaborator from the potential provider.
